(19) United States
(12) Patent Application Publication
(10) Pub. No.: US 2007/0143152 A1
(43) Pub. Date: Jun. 21, 2007

(54) Smart card for pharmaceutical consumer

(76) Inventor: Yaron Front, Haifa (IL)

Correspondence Address: Martin D. Moynihan;PRTSI, Inc., P. O. Box 16446, Arlington, VA, 22215, US

(21) Appl. No.: 11/640,310

(22) Filed: Dec. 18, 2006

Related U.S. Application Data
(60) Provisional application No. 60/750,836, filed on Dec. 16, 2005.

(51) Int. Cl. G06F 19/00; H04M 3/42

(52) U.S. Cl. 705/3; 379/211.05

(57) ABSTRACT

A smart card for assignment to a patient, comprises a processor, a memory and an interface for input and output of data. The card holds patient drug usage information, and obtains data from an external drug database regarding drugs stored in the usage information. The card calculates a warning about adverse drug interactions between any two drugs on the card; and a suggestion for one or more further drugs. The suggestion is based on the patient drug usage information.

### RELATED APPLICATIONS

This application claims priority from U.S. Provisional Patent Application No. 60/750,836, filed on Dec. 16, 2005. The contents of the above Patent Application are herein incorporated by reference.

### FIELD AND BACKGROUND OF THE INVENTION

The present invention relates to a smart card for a consumer of pharmaceutical products and, more particularly, but not exclusively to such a smart card that can provide information about possible adverse drug interactions whilst keeping the patient's medical records confidential.

Systems in which pharmaceutical consumption by a given patient is traced are known. An example is given by U.S. Pat. No. 6,421,650 to Goetz et al. which discloses a medication management system which includes three components to assist a patient control, monitor and manage administration of prescribed medications. The system comprises a patient component having a retrievable patient database of patient medical history, prior prescribed medications and current prescribed medications, and it includes a data transfer interface, e.g., a hardwired interface, such as an RS232 interface or infrared data transfer port. The system also includes a physician component having a retrievable physician's database of medication information and an input/output device enabling a prescribing physician to enter prescription information into the physician component. The physician's database is capable of receiving and storing patient data transferred from the patient component through said data transfer interface. The system finally also includes a pharmacist component resident on a pharmacist's computer. The pharmacist's computer is adapted to interface with said patient component to transfer prescription data to said pharmacist component. At least one of or each of the physician component and the pharmacist component has the capability of searching a medication database to determine potential medication interactions with currently prescribed medications and identify those to the physician or pharmacist for selective downloading to the patient component so that the patient can be alerted to the potential interactions. The patient component has a scheduler which tracks a plurality of medication dose schedules and includes alarm functions to prompt a patient to take particular medications, reschedule them, and alert the patient to potential interactions between medications and/or provide caution information to the patient for administration of the medication.

The system of Goetz is not fully satisfactory since it is widely encompassing, has elements for the doctor, pharmacist and patient and is thus of only limited application. Simpler systems that only contain the patient part or only contain the patient part or combine the patient and pharmacist part are also known.

An unrelated issue is that in certain countries, currently the USA and New Zealand, direct marketing of prescription-only drugs to consumers is allowed. Such direct marketing is very valuable since research shows that in 80% of cases, when a patient mentions a prescription drug to a doctor, the doctor will prescribe it. However the value of direct marketing of these drugs to consumers is relatively limited since most pharmaceuticals have very small and highly specific target populations for whom the drug is of interest. It is understood that the pharmaceutical companies of course are not permitted to access patient medical records.

Currently, loyalty cards etc are encouraged at given pharmacies to allow the pharmacy to follow buying habits, but this is of only limited applicability without the medical records.

### SUMMARY OF THE INVENTION

According to one aspect of the present invention there is provided an electronically readable card system, comprising an electronically readable card configured to work with an electronic reader and computational device, the electronically readable card comprising a memory storing details of pharmaceutical substances prescribed or consumed by a patient, the system being configured to use data stored in the memory to calculate an additional pharmaceutical substance likely to be of interest to the patient and to output a suggestion regarding the additional pharmaceutical substance.

Preferably, the system is further configured such that the details are retained within the card.

The system may comprise profile details of the patient, for additionally using to calculate the suggestion.

The system may be further configured to calculate adverse drug interactions between pharmaceutical substances whose details are stored in the memory and a pharmaceutical substance being newly added to the memory, and to output a warning of the adverse drug interactions.

The system may be further configured to provide a combined output of the warning and the suggestion.

Preferably, the card comprises calculating capacity and the warning and the suggestion are calculated on the card.

Preferably, the suggestion is additionally tested for adverse interactions with pharmaceuticals whose information is stored in the memory.

Optionally, each suggestion regarding each of said additional pharmaceutical substance(s) is retained within the card, optionally, with a date of the output of the suggestion.

According to a second aspect of the present invention there is provided a smart card for assignment to a patient, the card comprising a processor, a memory and an interface for input and output of data, the card memory being configured to hold patient drug usage information, the interface being configured to obtain data from an external drug database regarding drugs stored in the usage information, and the processor being configured to calculate:

a warning about adverse drug interactions between any two drugs of the patient drug usage information; and

a suggestion for a further drug based on the patient drug usage information.

Preferably, the smart card is further configured to store patient profile information in the memory, and to use the patient profile information in addition to the patient drug usage information to calculate the suggestion.

Preferably, the smart card is further configured to store each suggestion regarding each of the further drugs in the memory within the card to produce a suggestion history.

Optionally, the suggestion history includes a date of the output of each suggestion stored in the memory.

In some embodiments of the invention, the card is further configured to output suggestion history data via the interface.

Optionally, the output of suggestion history data occurs when a purchase of a drug occurs.

Optionally, the purchase includes a purchase of at least one suggested further drug.

In some embodiments of the invention, the smart cards operate in conjunction with a suggestion evaluation server configured to: (a) receive suggestion history data outputs from a plurality of smart cards as described above; and (b) evaluate efficacy of the suggestions.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified block diagram showing a smart card and reader according to a first preferred embodiment of the present invention;

FIG. 2 is a simplified diagram showing the database of FIG. 1 in greater detail; and

FIG. 3 is a simplified diagram illustrating the memory of a smart card being used according to a preferred embodiment of the present invention.

### DESCRIPTION OF THE PREFERRED EMBODIMENTS

The present embodiments comprise a smart card and reader apparatus which is assigned to a patient and which contains a patient profile and a list of drugs currently being taken. The card works together with external databases to provide the patient with important information about his prescribed drugs, in particular adverse drug interactions. In addition the profile and list of drugs are used together to suggest additional drugs that may be of use to the patient, and concerning which the patient may wish to consult his physician.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

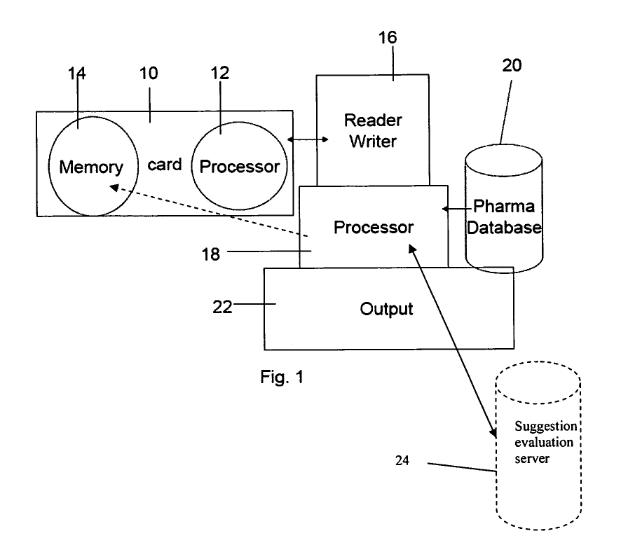

Reference is now made to FIG. 1, which is a simplified block diagram illustrating an electronically readable card system according to a first preferred embodiment of the present invention. The system comprises an electronically readable card 10, typically a smart card, which includes its own on-board processor 12 and memory 14. The smart card works with an electronic card reader/writer 16 to exchange data with the outside world.

The reader/writer is associated with a computer 18 and the computer has access to a database of pharmaceuticals 20.

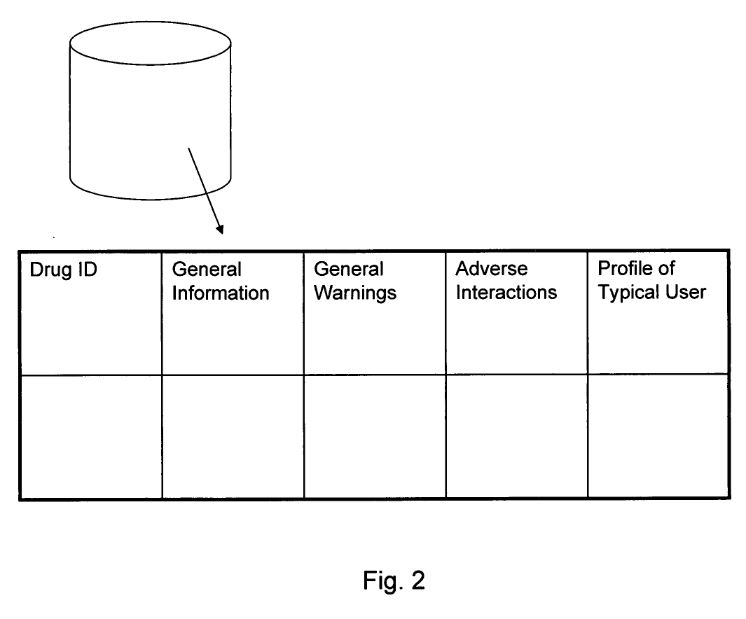

The database of pharmaceuticals 20 is shown in greater detail in FIG. 2. As seen in FIG. 2, the database 20 contains an identification of the drug or pharmaceutical substance itself in a first database field. In a second database field it contains general information about the drug. In a third field it contains general warnings about the drug. In a fourth field it contains data about other drugs that show adverse interactions with the first drug, including which drugs, how common the adverse interaction is, what the nature of the risk is, whether there is a particular kind of person who is most or least likely to suffer the interaction and any other relevant information. Finally there is a profile of the kind of person who is typically expected to require the identified pharmaceutical. The profile may be in terms of age, sex and other personal details of the typical patient, and may include other drugs that the typical user would be taking at the time.

Output 22 is connected to the processor 18 and provides the patient with an output, typically a printout, as will be described in greater detail below.

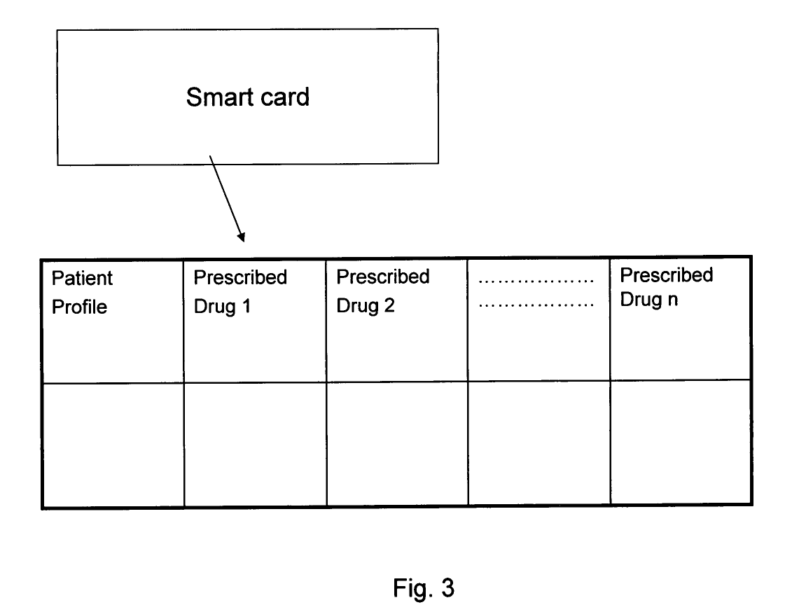

The electronically readable card 10 is assigned to a particular patient and allows information to be input about the assigned patient, as illustrated in FIG. 3. As shown in FIG. 3, basic patient profile data such as age and sex, major illnesses and the like are stored in a patient profile section. There follows a list of prescribed drugs including such details as date and duration of prescription, dosage etc.

In use, the system uses the patient profile data and list of prescribed drugs from the memory together with the database 20 to provide the user with general information, and general warning information, about any new pharmaceutical he is prescribed. In addition the new pharmaceutical is checked for adverse interactions with any other pharmaceutical listed in the card memory 14 and an adverse interaction warning is given to the patient. The adverse interaction warning may tell the patient if he is at high risk or low risk, based on a comparison of his own data with the adverse interaction data stored on database 20.

In a preferred embodiment of the present information, the data from the pharmaceutical database is downloaded onto the smart card and all necessary comparisons and logic are carried out on the card's internal processor 12. In this way no external body is given access to the patient's confidential medical records.

The card's internal processor 12 preferably also checks through the typical user profiles (FIG. 2) of additional drugs that the patient is not currently receiving to find close matches to the patient. Drugs showing a close match are then added to the output as a suggestion. The patient is provided with useful information about the drug, the reasons why it may be of benefit and is invited to ask his doctor about the drug.

In this way the pharmaceutical providers are able to target their marketing of drugs to consumers to whom the specific drug is likely to be of interest. At the same time no outside body gains access to the patient's confidential medical records, which remain securely locked inside the patient's smart card.

The card reader/writer may be provided as a stand-alone unit at a doctor's surgery, at the hospital or at a pharmacist. The unit may be directly connected to processor 18 or connected via a communication link or network. The pharmaceutical database 20 may be directly connected to the processor 18 or rendered available via a communication link or network.

The output device 22 is typically but not exclusively a printer.

When a new drug is prescribed to a patient or purchased at a pharmacist, the card is simply placed in association with the reader/writer where details of the new drug are entered. The card asks for relevant information from the database and checks for general information about the drug, information about adverse interactions with drugs already stored in the memory etc, considers the patient profile in relation to the information gathered and looks for a further drug most closely matching the patient's profile and/or list of prescribed drugs. The information is then output to the user, preferably in the form of a printed sheet.

It is pointed out that non-prescription material can also be added to the card to aid in generating a profile of suitable products for the suggestion. The suggested products may themselves be products other than prescription drugs.

As explained, numerous patients take five drugs or more. The use of five drugs or more corresponds with a chance of an adverse drug interaction of approximately, 50%. The chances are that the kind of patient who receives five drugs or more is being treated by more than one physician, and the physicians may not be in communication with each other. Furthermore, patients taking five or more drugs are less likely to be able to communicate effectively with their physicians to explain clearly what other drugs they may be taking.

Use of the above system is intended to reduce the likelihood of adverse drug interactions by providing warnings, to better educate the patient on the issue of adverse drug interactions so that he can communicate more efficiently with his physician and to inform him of additional drugs that may be suitable for his condition, again to enable him to better communicate with his physician. Preferably the adverse interaction information is used in order to improve the suggestion of the additional drug, such that the physician can be confident that any additional drug suggested by the card at least does not have an adverse interaction with drugs already being taken by the patient.

Referring again to FIG. 1, smart card 10 is optionally configured to store each suggestion regarding each of the further drugs in the memory 14 within card 10 to produce a suggestion history as indicated by the dotted arrow from computer 18 to memory 14. The suggestion history can include a date of the output of each suggestion stored in memory 14.

In some embodiments of the invention, card 10 is further configured to output suggestion history data via the interface to computer 18. Optionally, the suggestion history output is relayed to a suggestion evaluation server 24. Optionally, the output of suggestion history data occurs when card 10 is used, for example when a purchase of a drug occurs. In some embodiments of the invention output of suggestion history data occurs when at least one suggested further drug is purchased.

In an exemplary embodiment of the invention, suggestion evaluation server 24 is configured to receive suggestion history data outputs from a plurality of smart cards 10 and evaluate efficacy of the suggestions. Suggestion efficacy can be expressed as, for example, average number of suggestion exposures prior to purchase of a suggested drug and/or average latency between first exposure to a suggestion and initial purchase of a suggested drug and/or percentage of cardholders exposed to a particular suggestion that eventually purchase the selected drug.

Optionally, communication between suggestion evaluation server 24 and computers 18 is bidirectional. Optionally, formatted suggestions from a suggestion database on server 24 are stored on computer 18 until an internal processor 12 of a card 10 determines one or more additional drugs that the patient is not currently receiving which could be suggested.

In an exemplary embodiment of the invention, server 24 provides formatted suggestions for a wide variety of drugs to computer 18. When processor 12 of card 10 indicates a particular drug to be suggested, a formatted suggestion for that drug stored on computer 18 is presented. In an exemplary embodiment of the invention, the suggestion is sent to display device 22 (e.g. printer or display) and/or stored as part of a suggestion history in memory 14 of card 10.

Optionally, using computer 18 as an intermediary prevents relay of sensitive patient information to server 24.

Optionally, processor 12 of card 10 sends a request for a formatted suggestion for a specific drug directly to data base 24. In an exemplary embodiment of the invention, the request includes no personal medical information from a patient holding card 10.

Optionally, formatted suggestions provided by server 24 include graphics as well as text. Optionally, output device 22 includes a display screen and speakers and the formatted suggestion includes animated graphics and/or video presentation and/or sound (e.g. music and/or voice).

Optionally, each formatted suggestion provided by server 24 is identified by a suggestion ID code. The code can be for example, a 4, 6 or 8 member alphanumeric string. In an exemplary embodiment of the invention, the suggestion history includes only suggestion ID codes and dates of presentation. Optionally, storing of suggestion ID codes in the suggestion history contributes to a reduction in demand on memory 14 of card 10. For example if a user is presented with a 15 second video suggestion for multi-vitamins while their prescription is being filled, the suggestion exposure can be recorded in a suggestion history as a 6 digit number followed by the date.

Although Pharma database 20 and evaluation server 24 are depicted as separate items in FIG. 1, the can be integrated into a single piece of hardware with no substantial effect on the invention. Conversely, Pharma database 20 and/or evaluation server 24 can each comprise two or more pieces of hardware acting in concert to describe the functions described above.

It is expected that during the life of this patent many relevant devices and systems will be developed and the scope of the terms herein, in particular of the term “smart card” is intended to include all such new technologies a priori.

The terms “drug” and “pharmaceutical” are used herein synonymously.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An electronically readable card system, comprising an electronically readable card configured to work with an electronic reader and computational device, the electronically readable card comprising a memory storing details of pharmaceutical substances prescribed or consumed by a patient, the system being configured to use data stored in said memory to calculate an additional pharmaceutical substance likely to be of interest to said patient and to output a suggestion regarding said additional pharmaceutical substance.

2. The electronically readable card system of claim 1, wherein the system is further configured such that said details are retained within said card.

3. The electronically readable card system of claim 1, further comprising profile details of said patient, for additionally using to calculate said suggestion.

4. The electronically readable card system of claim 1, further configured to calculate adverse drug interactions between pharmaceutical substances whose details are stored in said memory and a pharmaceutical substance being newly added to said memory, and to output a warning of said adverse drug interactions.

5. The electronically readable card system of claim 4, further configured to provide a combined output of said warning and said suggestion.

6. The electronically readable card system of claim 4, wherein said card comprises calculating capacity and said warning and said suggestion are calculated on said card.

7. The electronically readable card system of claim 6, wherein said suggestion is additionally tested for adverse interactions with pharmaceuticals whose information is stored in said memory.

8. The electronically readable card system of claim 1, wherein the system is further configured so that each suggestion regarding each of said additional pharmaceutical substance is retained within said card.

9. The electronically readable card system of claim 8, wherein each suggestion is retained with a date of the output of the suggestion.

10. A smart card for assignment to a patient, the card comprising a processor, a memory and an interface for input and output of data, the card memory being configured to hold patient drug usage information, the interface being configured to obtain data from an external drug database regarding drugs stored in said usage information, and said processor being configured to calculate:
a warning about adverse drug interactions between any two drugs of said patient drug usage information; and
a suggestion for a further drug based on said patient drug usage information.

11. The smart card of claim 10, further configured to store patient profile information in said memory, and to use said patient profile information in addition to said patient drug usage information to calculate said suggestion.

12. A smart card of claim 10, wherein the card is further configured to store each suggestion regarding each of said further drugs in the memory within said card to produce a suggestion history.

13. A smart card of claim 12, wherein the suggestion history includes a date of the output of each suggestion stored in the memory.

14. A smart card of claim 12, wherein the card is further configured to output suggestion history data via the interface.

15. A smart card of claim 14, wherein the output of suggestion history data occurs when a purchase of a drug occurs.

16. A smart card of claim 15, wherein the purchase includes a purchase of at least one suggested further drug.

17. A suggestion evaluation server, the server configured to:
(a) receive suggestion history data outputs from a plurality of smart cards according to claim 12; and
(b) evaluate efficacy of the suggestions.
